(19) United States
(12) Patent Application Publication
(10) Pub. No.: US 2007/0076649 A1
(43) Pub. Date: Apr. 5, 2007

(54) Techniques for heterogeneous radio cooperation

(75) Inventors: Xintian E. Lin, Mountain View, CA (US); Qinghua Li, Sunnyvale, CA (US); Sumeet Sandhu, San Jose, CA (US)

Correspondence Address: KACVINSKY LLC, Suite 102, 4500 Brooktree Road, Wexford, PA, 15090, US

(73) Assignee: Intel Corporation

(21) Appl. No.: 11/239,984

(22) Filed: Sep. 30, 2005

(51) Int. Cl. H04Q 7/00

(52) U.S. Cl. 370/328

(57) ABSTRACT

A cooperative communications manager module establishes a first wireless link with a client device using a first channel frequency and dispatches a first message to the client device over the first channel frequency. The cooperative communications manager module establishes a second wireless link with a destination node and controls the cooperative transmission of the first message simultaneously with the client device to the destination node over the second wireless link using a second channel frequency. Other embodiments are described and claimed.

### BACKGROUND

Various communication systems exist today to allow electronic devices, e.g., computers, mobile devices, and/or personal communication devices, to communicate and exchange information such as voice and multimedia information (e.g., video, sound, data) over local and distributed networks. Various wireless communication systems, allow wireless adapted computers to communicate with each other and wireless devices and computers connected to other networks such as Internet.

Wireless communication networks are being deployed pervasively in enterprise, residential, and public hotspots based on a variety of wireless standards. These wireless communication networks may employ multiple wireless technologies and wireless access standards. Accordingly, mobile wireless platforms are required to support multiple heterogeneous wireless devices (e.g., radios) to communicate over the multitude of different technology based wireless networks (e.g., heterogeneous wireless networks). To communicate across the heterogeneous wireless networks, wireless devices may include multiple wireless device technologies to seamlessly transition within a wireless network or across multiple wireless networks. Thus, there may be a need for a wireless network to support heterogeneous and homogeneous handovers to implement seamless connectivity between wireless devices. Heterogeneous handovers entail transitions across the different wireless networks. Homogeneous handovers entail transitions within access points (APs) or base stations.

### BRIEF DESCRIPTION OF THE DRAWINGS

FIG. 1 illustrates one embodiment of a cooperative heterogeneous wireless network 100.

FIG. 2 illustrates one embodiment of heterogeneous wireless device cooperative network data flow diagram 200.

FIG. 3 illustrates one embodiment of a communication system 300 implementation of heterogeneous wireless network 100.

FIG. 4 illustrates one embodiment of a wireless device 400.

FIG. 5 illustrates one embodiment of a logic flow 500 of information exchanged between heterogeneous wireless devices in heterogeneous wireless network 100.

### DETAILED DESCRIPTION

The embodiments may generally relate to wireless communication networks. One embodiment relates to heterogeneous wireless cooperative communication networks to support communication over a multitude of wireless networks and nodes associated therewith using multiple heterogeneous wireless devices. In various embodiments, the heterogeneous wireless devices may comprise fixed, stationary or mobile wireless devices, including, but not limited to, multi-network/multifunctional wireless devices comprising multiple integrated wireless devices and mixed-network devices supporting multiple concurrent wireless technology standards. The embodiments are not limited in this context.

Examples of systems and devices in which embodiments described herein can be incorporated comprise wireless local area network (WLAN) systems, wireless metropolitan area network (WMAN) systems, wireless personal area networks (WPAN), wide area networks (WAN), cellular telephone systems, radio networks, computers, and wireless communication devices, among others. Those skilled in the art will appreciate, based on the description provided herein, that the embodiments may be used in other systems and/or devices. The embodiments, however, are not intended to be limited in context to the systems and/or devices described herein.

Embodiments of systems and nodes described herein may comply or operate in accordance with a multitude of wireless standards. For example, a system and associated nodes may comply or communicate in accordance with one or more wireless protocols, which may be defined by one or more protocol standards as promulgated by a standards organization, such as the Internet Engineering Task Force (IETF), International Telecommunications Union (ITU), the Institute of Electrical and Electronics Engineers (IEEE), and so forth. In the context of a WLAN system, the nodes may comply or communicate in accordance with various protocols, such as the IEEE 802.11 series of protocols (e.g., wireless fidelity or WiFi). In the context of a WMAN system, the nodes may comply or communicate in accordance with the IEEE 802.16 series of protocols such as the Worldwide Interoperability for Microwave Access (WiMAX), for example. Those skilled in the art will appreciate that WiMAX is a standards-based wireless technology to provide high-throughput broadband connections over long distances (long range). WiMAX can be used for a number of applications, including “last mile” wireless broadband connections, hotspots, cellular backhaul, and high-speed enterprise connectivity for business. In the context of a personal area network (PAN), the nodes may comply or communicate in accordance with the IEEE 802.15 series of protocols otherwise known as Bluetooth, for example. In the context of a MAN, the nodes may comply or communicate in accordance with the IEEE 802.20 series of protocols, for example. For mobility across multiple networks, the nodes may comply or communicate in accordance with the IEEE 802.21 series of protocols, for example. In other embodiments, the system and nodes may comply with or operate in accordance with various WMAN mobile broadband wireless access (MBWA) systems, protocols, and standards, for example. The embodiments, however, are not limited in this context.

Embodiments of systems and nodes described herein may comply or operate in accordance with a multitude of wireless technologies and access standards. Examples of wireless technologies and standards may comprise cellular networks (e.g., Global System for Mobile communications or GSM), Universal Mobile Telecommunications System (UTS), High-Speed Downlink Packet Access (HSDPA), Broadband Radio Access Networks (BRAN), General Packet Radio Service (GPRS), 3^{rd} Generation Partnership Project (3GPP), and Global Positioning System (GPS); and Ultra Wide Band (UWB), among others. Systems and nodes in accordance with various embodiments may be arranged to support multiple heterogeneous wireless devices to communicate over these wireless communication networks. The embodiments, however, are not limited in this context.

Embodiments of systems and nodes described herein may comply with or operate in accordance with one or more cellular protocols or standards. These cellular standards or protocols may comprise, for example, GSM, Code Division Multiple Access (CDMA), CDMA 2000, Wideband Code-Division Multiple Access (W-CDMA), Enhanced General Packet Radio Service (EGPRS), among other standards, for example. The embodiments, however, are not limited in this context.

Embodiments of systems and nodes described herein may comprise wireless devices that may include multiple radios adapted to support multiple wireless standards, frequency, bandwidth, and protocols to seamlessly transition within a wireless network or across multiple wireless networks. Embodiments of systems and nodes described herein may be adapted to support heterogeneous and homogeneous handovers over one or more wireless networks and may be adapted to implement seamless connectivity between multiple wireless devices. Heterogeneous handovers entail transitions across different wireless networks including, but not limited to, those described herein (e.g., WLAN, WiFi, WMAN, WiMAX, cellular networks, UWB, Bluetooth, among others). Homogeneous handovers entail transitions across network points of attachments such as WLAN APs or WiMAX base stations. The embodiments are not limited in this context.

Wireless communication devices may comprise, for example, client devices and network points of attachments. Client devices and network points of attachments may be fixed, stationary or mobile depending on the particular environment or implementation and may communicate over the medium of free space generally referred to as the “air interface” (e.g., wireless shared media). Client devices may be adapted for short hop relay operation that cooperate between relatively nearby nodes and can simultaneously communicate cooperatively with a network point of attachment at another node. Client devices may be adapted for fast, short range, and flexible/ad hoc wireless transmissions over point-to-point relay links established between relatively nearby nodes. In one embodiment, client devices may comprise wireless devices that comply with or operate in accordance with one or more protocols and/or standards, such as, for example, WiFi, Bluetooth, UWB, WiMAX or cellular protocols and/or standards. A client device may be fixed, stationary or mobile. For example, a client device may include, but is not necessarily limited to, a computer, server, workstation, laptop, ultra-laptop, handheld computer, telephone, cellular telephone, personal digital assistant (PDA), router, switch, bridge, hub, gateway, wireless device, multi-network/multifunctional devices, multiple integrated radio devices, mixed-network device supporting multiple concurrent radios, WiFi plus cellular telephone, portable digital music player (e.g., Motion Pictures Experts Group Layer 3 or MP3 players), pager, two-way pager, mobile subscriber station, printer, camera, enhanced video and voice device, and any other one-way or two-way device capable of communicating with other devices or base stations. Those skilled in the art will appreciate that client devices may be adapted to operate in accordance with standards-based wireless technologies such as WiFi, UWB, and Bluetooth to establish point-to-point links and to provide seamless wireless communication of voice, video, and data between both mobile and stationary client devices over short distances (short-range). The embodiments are not limited in this context.

Network points of attachment may comprise wireless devices adapted for long range, periodic, scheduled cooperative wireless transmissions over cooperative links between multiple nodes. In one embodiment, a network point of attachment may comprise wireless devices adapted to comply with or operate in accordance with WiFi, Bluetooth, UWB, WiMAX or cellular protocols and/or standards. Network points of attachment may include, but are not necessarily limited to, wireless APs, WiFi WLAN APs (e.g., hotspots), WiMAX wireless broadband base stations, and any other device capable of acting as a communication hub for wireless client devices to connect to a wired network from a wireless network and to extend the physical range of service of a wireless network. The embodiments are not limited in this context.

In one embodiment, the client devices and network points of attachment may be adapted to operate in a cooperative wireless network implementation. In one embodiment, the client devices may be adapted for fast, short range, and flexible/ad hoc relay wireless communications that serve point-to-point relay links between multiple nearby nodes in one wireless network. Network points of attachment may be adapted for long range, scheduled periodic wireless communications that serve cooperative links between multiple other nodes in another wireless network. This arrangement may leverage on special advantages of the two wireless networks: one to implement ad hoc Media Access Control (MAC) accesses to relay point-to-point messages, the other to implement a coordinated simultaneous uplink arrangement, for example. Embodiments of systems and nodes described herein may be arranged to provide seamless wireless short-range communications of voice, video, and data between client devices and corporative communications between client devices and network points of attachments. The embodiments are not limited in this context.

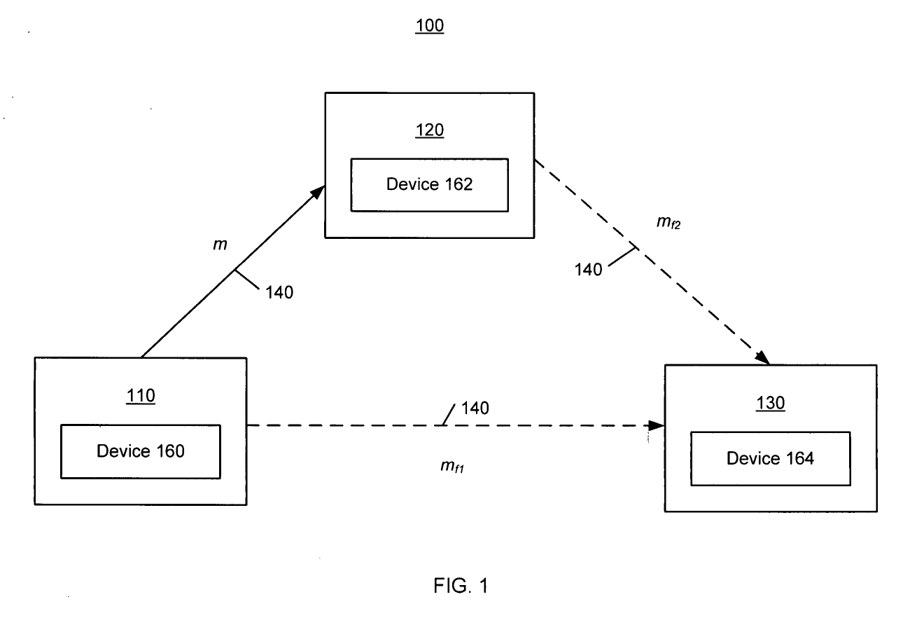

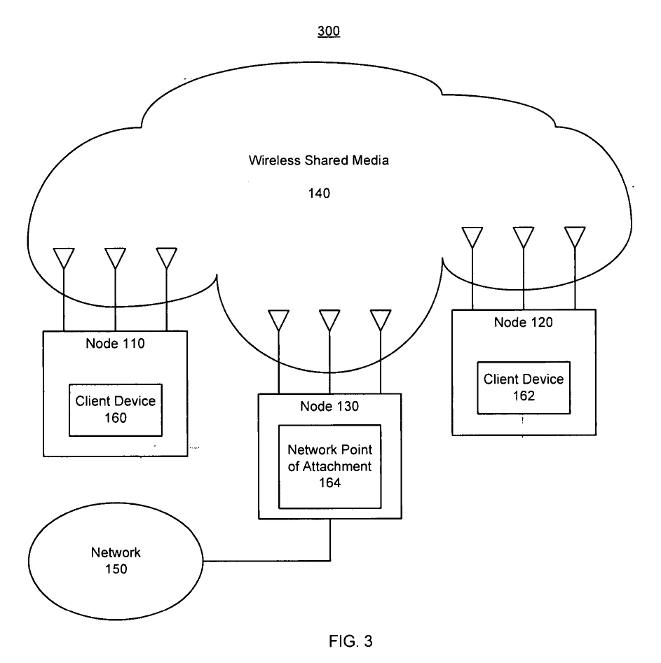

FIG. 1 illustrates one embodiment of a cooperative heterogeneous wireless network 100. In one embodiment, heterogeneous wireless network 100 may comprise nodes 110, 120, 130. Nodes 110, 120, 130 communicate over wireless shared media 140. In the illustrated embodiment, node 110 may be a wireless client device designated as a source (S) node, node 120 may be a wireless client device designated as a relay (R) node, and node 130 may be a network point of attachment designated as a destination (D) node, for example. In heterogeneous wireless network 100, several wireless client devices at each of S and R nodes 110, 120 may cooperate and transmit messages simultaneously to communicate with D node 130 that otherwise cannot be reached because of the physical distance between S node 110 and D node 130, R node 120 and D node 130. In one embodiment, cooperation of S and R nodes 110, 120 may be implemented with beam forming, spatial diversity or frequency diversity, for example. Nodes 110, 120, 130 are described in more detail below with reference to FIG. 3. The embodiments are not limited in this context.

In the illustrated embodiment, S node 110 transmits a message m using a first subcarrier frequency f to relay R node 120 over wireless shared media 140, for example. Subsequently, correlated messages m_{f1} and m_{f2} are simultaneously transmitted to destination D node 130 from respective S and R nodes 110, 120 over wireless shared media 140, for example. Message m_{f1} is transmitted using the first subcarrier frequency f₁ and message m_{f2} is transmitted using a second subcarrier frequency f₂. In one embodiment of heterogeneous wireless network 100, wireless client devices at each of respective nearby S and R nodes 110, 120 may establish a point-to-point link therebetween to dispatch relay message m from S node 110 to R node 120 over wireless shred media 140. S and R nodes then cooperate by beam forming and transmit messages m_{f1} and m_{f2} to D node 130 simultaneously over wireless shared media 140. In one embodiment, the frequencies f₁ and f₂ may be the same and communications between nodes 110, 120, 130 may be carried out using beam forming gain and/or spatial diversity gain, for example. This type of simultaneous correlated cooperative communication may be referred to as “Virtual Multiple-Input Multiple-Output (MIMO).” In yet another embodiment, the frequencies f₁ and f₂ may be different and communications between nodes 110, 120, 130 may be carried out using spatial and frequency diversity, for example. In yet another embodiment, the frequencies f, f₁ and f₂ may be the same. The embodiments are not limited in this context.

In one embodiment, S and R nodes 110, 120 may comprise respective wireless client devices 160, 162 that may operate on independent clocks. In various embodiments, S and R nodes 110, 120 may comprise respective wireless client devices 160, 162 implemented as WiFi, Bluetooth, UWB, and WiMAX compliant radios, for example, to establish a point-to-point link therebetween. The nearby S and R nodes 110, 120 then cooperate by beam forming to dispatch relay messages m_{f1} and m_{f2} to D node 130 using WiMAX technology, for example. In one embodiment, respective wireless client devices 160, 162 may communicate simultaneously with one or more wireless devices 164 at D node 130 if the respective clocks of wireless devices 160, 162 are locked to the clock of wireless device 164 at D node 130, for example. In a heterogeneous wireless radio network environment using Orthogonal Frequency Division Modulation (OFDM) multiple access heterogeneous radio technologies can be used to communicate in WiFi, Bluetooth, UWB, and WiMAX compliant modes, among others, a carrier modulation technique that transmits data across many carriers for high data rates at lower symbol rates used in digital transmissions. OFDM multiple access techniques may be used for high speed data access systems such as IEEE 802.11a/g WAN (WiFi) and IEEE 802.16a/d/e wireless broadband access systems (WiMAX), for example. In heterogeneous wireless network 100 environment both S node 110 and R node 120 may communicate with each other using any available radio technology (e.g., WiFi, Bluetooth, and UWB, among others) and then may cooperate by beam forming to communicate with base station D node 130 simultaneously using WiMAX radio technology, for example. WiMAX multiple access techniques require the respective clocks of S node 110 and R node 120 to be locked to the base station D node 130 clock with high accuracy. This stringent requirement enables S and R nodes 110, 120 to communicate with D node 130 using WiMAX radio technology simultaneously, for example. The embodiments are not limited in this context.

In conventional wireless implementations, due to the independent crystal clock operation in S and R nodes 110, 120, it may be difficult to establish a coherent direct link between S node 120 and D node 130, and between R node 120 and D node 130 in terms of timing offset and carrier frequency offset. Furthermore, in cellular WiMAX wireless network implementations (not mesh implementations) direct communications between two nearby WiMAX subscriber stations (e.g., between WiMAX compliant S and R nodes 110, 120) may not be permitted because the WiMAX network schedule is centralized at the network point of attachment node (e.g., base station) located at D node 130, for example. The embodiments are not limited in this context.

Accordingly, in one embodiment of heterogeneous wireless network 100, wireless devices 160, 162 at respective S and R nodes 110, 120 may serve as short distance “dispatch” links to implement a WiMAX cooperative wireless communication between S node 110 and D node 130, and between R node 120 and D node 130. In one embodiment, for example, wireless devices 160 and 162 may comprise WiFi, Bluetooth, and/or UWB radios to serve as short distance “dispatch” links and may comprise WiMAX radios to realize a WiMAX cooperative wireless communications link with a WiMAX base station at D node 130, for example. The embodiments are not limited in this context.

One embodiment of heterogeneous wireless network 100 may be described with respect to the following example. S node 110 may be implemented as a laptop personal computer (PC) adapted with WLAN (e.g., WiFi) and WMAN (e.g., WiMAX) compliant wireless device 160. R node 120 may be implemented as a wireless handset adapted with WLAN (e.g., WiFi) and WMAN (e.g., WiMAX) compliant wireless device 162. It will be appreciated that both the laptop PC S node 110 and the wireless handset R node 120 also may comprise Bluetooth, UWB or other similar radio in addition to a WiMAX radio. The laptop PC and the handset may belong to the same user or to different users and, in this example, are located in close proximity to each other. In operation, the laptop PC S node 110 initially may send relay data (e.g., in the form of message m using subcarrier frequency f over wireless shared media 140) to the wireless handset R node 120 using WiFi (Bluetooth, UWB or the like), which does not consume WiMAX bandwidth. Subsequently, both the laptop PC and the wireless handset may cooperate by beam forming and simultaneously transmit beam formed data to base station D node 130, which otherwise could not be reached without beam forming. In one embodiment, frequencies f₁ and f₂ may be different such that message m_{f1} is transmitted from S node 110 to D node 130 at subcarrier frequency f₁ and message m_{f2} is transmitted from R node 120 to D node 130 at subcarrier frequency f₂ simultaneously. In one embodiment, frequencies f₁ and f₂ may be the same. Using WiFi (Bluetooth, UWB or the like), the two WiMAX devices in vicinity (e.g., the laptop PC at S node 110 and the wireless handset at R node 120) can share their respective radios to perform MIMO communications with base station D node 130. This MIMO mode can increase the number of spatial streams to the destination node D over what may be achieved by node S alone. Because WiFi (Bluetooth, UWB or the like) and WiMAX can operate simultaneously on different frequency bands, the efficiency of the WiMAX system may be improved using this implementation, for example. The embodiments are not limited in this context.

In one embodiment, D node 130 may be implemented as a WiMAX base station as the cooperating technology. Accordingly, WiMAX technology may be used for cooperative beam forming rather than just open-loop space-time coding. The gain (in dB) with beam forming=log(M), where M is the number of antennas in the system. Thus, in general a good cooperative heterogeneous wireless network 100 may comprise any radios with good synchronization technology and good ad hoc communication technology.

In one embodiment, heterogeneous wireless network 100 may be implemented as a WiMAX network to leverage the narrower bandwidth and lower delay spread of WiMAX technology over WiFi technology. Thus, a WiMAX implementation of heterogeneous wireless network 100 may gain additional benefits from spatial diversity using cooperation than would a WiFi network implementation, for example. It will be appreciated that cooperation will be more useful in a network where spatial diversity provides a bigger gain. It will be appreciated that heterogeneous wireless network 100 also may be implemented using any technology that can leverage from the benefits of narrower bandwidth and lower delay spread (relative to WiFi) and may be generalized to any technology with good synchronization or narrower bandwidth than another technology (e.g., UWB).

In addition, heterogeneous wireless network 100 may be implemented such that client devices with wireless devices adapted for communication with multiple wireless networks including a specific wireless network can assist other client devices that do not include wireless devices adapted to communicate over the specific wireless network. For example, client device 160 may include functional modules to communicate over WiFi, Bluetooth, UWB, cellular, and/or WiMAX networks and client device 162 may include functional modules to communicate over WiFi, Bluetooth, UWB, cellular but not WiMAX, for example. Accordingly, if client device 162 wants to communicate with network point of attachment node 130 implemented as a WiMAX base station, client device 162 can establish a point-to-point wireless link with client device 160 and transfer messages (e.g., packets) to client device 160. Subsequently, client device 160 can establish a synchronous wireless link with network point of attachment node 130 to transmit the messages received from client device 162.

In another example, where both client devices 160, 162 include functional modules to communicate over WiFi, Bluetooth, UWB, cellular, and/or WiMAX networks, client device 160 can assist client device 162 to communicate in WiMAX mode if client device 162 is running low on battery power. In this example, client device 160 can relay WiMAX packets (e.g., with higher transmit power) to wireless device 164. Both cooperating client devices 160, 162 may exchange data packets and cooperatively transmit the packets on their respective time/frequency/code channels, for example.

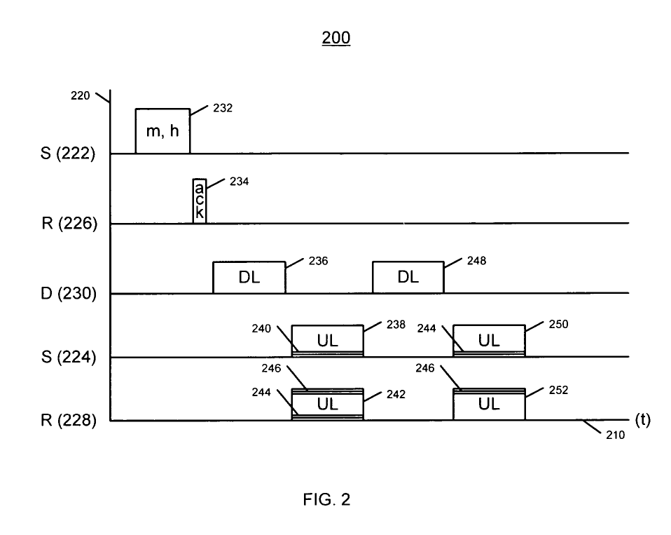

FIG. 2 illustrates one embodiment of a heterogeneous wireless device cooperative network data flow diagram 200. Diagram 200 illustrates the transmission of packets in a cooperative implementation of heterogeneous wireless network 100, for example. The horizontal axis 210 represents time and the vertical axis 220 represents the different radios that may be located at each of S node 110 and R node 120. For example, in one embodiment, S node 110 may comprise WiFi radio 222 and WiMAX radio 224; R node 120 may comprise WiFi radio 226 and WiMAX radio 228; and D node may comprise WiMAX base station radio 230. Assume that S and R nodes 110, 120 are in close proximity to each other, include WiFi, Bluetooth, UWB, and WiMAX compliant wireless devices, and are adapted for fast, short range, and flexible/ad hoc wireless transmissions over point-to-point relay links established therebetween. Further assume that network point of attachment D node 130 is realized as a WiMAX base station and that S and R nodes 110, 120 individually cannot communicate with base station D node 130 at some data rates. The communication failure may be caused by a high packet error rate, for example. Finally, assume that message m is to be transmitted from S node 110 to D node 130. The embodiments are not limited in this context.

In the following example, message m is to be transmitted from S node 110 to D node 130 by way of R node 120. In phase one, after a point-to-point link is established between S node 110 and R node 120, using client device 160, S node 110 initiates a transmission 232 of message m to client device 162 at nearby R node 120. In this mode of operation, client devices 160, 162 may be referred to, for example, as relay type wireless devices. A relay type wireless device may comprise any wireless device that can establish a relay link between nodes and can provide fast, short range, and flexible/ad hoc wireless communications between the nodes. In a WLAN network implementation, for example, a relay type wireless device may comprise WiFi, Bluetooth or UWB wireless devices, although the embodiments are not limited in this context. In addition to message m, transmission 232 from S node 110 to R node 120 may include any coordination information for beam forming to D node 130. Such information may comprise, for example, uplink frame ID, requested adaptive modulation and coding (AMC) band index, and optionally some channel related information h and coordination information. R node 120 acknowledges a successful reception of message m by transmitting an ACK (acknowledge) message 234 back to S node 110. The embodiments are limited in this context.

D node 130, which in this example is implemented as a WiMAX base station, periodically transmits downlink messages 236, 248, and so on to WiMAX wireless devices, such as S and R node 110, 120 wireless client devices. Downlink message 236 is received by S node 110 and R node 120. The packet 236 may be aligned after ACK packet 234 as shown in the diagram, or it may not. In this example, D node 130 sets frequencies f₁ and f₂ for transmission by S and R nodes 110, 120, respectively. It is appreciated that the node R decodes the control message and therefore knows the subsequent cooperative frequency f₁ for node S.

In phase two, using cooperative type wireless client device 160, S node 110 transmits uplink message 238 to D node 130. Uplink message 238 includes cooperative message m₁ 240 on frequency f₁. Simultaneously with transmission 238, R node 120 transmits uplink message 242 to D node 130. At least part of the message includes message m₂ transmitted on frequency f₁, the set frequency for node S. Messages m₁ and m₂ are correlated to message m node S relayed to node R. It will be appreciated that S and R nodes 110, 120 can transmit cooperative messages 240, 244 to D node 130 simultaneously in a beam forming manner using cooperative set frequency f₁. It will be appreciated that S and R nodes 110, 120 also can transmit cooperative messages 240, 244 to D node 130 simultaneously in an Alamouti coding scheme, for example. During transmission 242, R node 120 also may transmit additional uplink messages, such as, for example, message 246 using the other set frequency f₂, for example. As used herein, a cooperative type wireless device comprises any wireless device that can establish long range, scheduled cooperative synchronous wireless links between multiple nodes to provide long range cooperative synchronized wireless communications between the multiple nodes. In a WiMAX network implementation, for example, a cooperative type wireless device may comprise any wireless device adapted to communicate in accordance with the WiMAX standard, although the embodiments are not limited in this context.

Prior to beam forming, S node 110 and R node 120 may learn respective channel state information (of a given subcarrier) from S node 110 to D node 130 and from R node 120 to D node 130. In one embodiment, the channel state information may be denoted in terms of magnitude and phase as α_{S}e^{jθ}^{_{S}} and α_{R}e^{jθ}^{_{R}}, respectively. To transmit message m to D node 130, the cooperative signal representing message m should be constructively superimposed during beam forming. Accordingly, S node 110 and R node 120 may multiply the magnitude and phase signals representing message m by α_{S}e^{-jθ}^{_{S}} and α_{R}e^{-jθ}^{_{R}}, respectively, for example. When the channel amplitude information is not available, S node 110 and R node 120 may multiply message m by e^{-jθ}^{_{S}} and e^{-jθ}^{_{R}} respectively. Message m is then transmitted simultaneously from S node 110 and R node 120 using the subcarrier f₁ allocated to S node 110. It is not necessary to multiply both signals, only multiplying the ratio on one signal is enough for two node cooperation. It will be appreciated that the concept may be extended to additional nodes. If no channel state information is acquired beforehand, S node 110 and R node 120 may conduct coherent space-time block coding such as Alamouti coding for diversity gain, for example. It will be appreciated that coherent space-time block codes (STBCs) such as Alamouti type coherent space-time block coding is a redundant transmission technique used in wireless communications to transmit multiple copies of an information stream across a number of antennas in order to exploit the various received versions of the information to improve the transfer reliability of the information. During transmission, for example, transmitted information must traverse potentially difficult environments and may be corrupted by scattering, reflection, refraction, and/or thermal noise at the receiver end. Accordingly, some of the received copies of the information will generally be “better” than others. This redundancy results in a higher probability of using one or more of the received copies of the information to correctly decode the received signal. In various implementations, space-time coding techniques may combine all copies of the received signal in an optimal way to extract as much of the information from each of them as possible. In other embodiments, S node 110 and R node 120 also may conduct random beam forming. The embodiments are limited in this context.

D node 130 continuously transmits periodic downlink messages 248. Subsequently, S node 110 may transmit uplink message 250 on frequency f₁ and R node 120 may transmit uplink message 252 on frequency f₂ without cooperation, for example. Additional coordination message may be transmitted to node D to help decoding the messages.

The wireless devices 160, 162, 164 at any one of S, R, and D nodes 110, 120, 130 may operate on different frequency bands f₁, and f₂ simultaneously. Accordingly, transmission 232 of message m from S node 110 to R node 120 in relay mode does not consume channel bandwidth in cooperative mode. For example, if message 232 is transmitted from S node 110 to R node 120 in a WiFi, Bluetooth or UWB transmission, message 232 does not consume WiMAX bandwidth. If R node 120 transmits an additional message with relay message m as part of message 246, R node 120 may employ a different user identification (ID) code and subcarriers (e.g., f₂) or different time slots other than those utilized for relay message m. For example, message 246 may be transmitted using subcarrier f₂ for the additional relay message mᵣ transmitted by R node 120 alone and message 244 may be transmitted using subcarrier f₁ for the beam formed relay message m transmitted simultaneously by S node 110 and R node 120. In one embodiment, S node 110 and R node 120 may optionally exchange channel state information. This may provide better cooperation, for example. The embodiments are not limited in this context.

FIG. 3 illustrates one embodiment of a communication system 300 implementation of heterogeneous wireless network 100. FIG. 3 may illustrate, for example, a block diagram of a system 300. System 300 may comprise, for example, a communication system having multiple nodes. A node may comprise any physical or logical entity having a unique address in system 300. The unique address may comprise, for example, a network address such as an Internet Protocol (IP) address, a device address such as a MAC address, and so forth. Examples of nodes include, but are not necessarily limited to, systems and devices such as client devices and network points of attachment, for example. The embodiments are not limited in this context.

Embodiments of the nodes of system 300 may be arranged to communicate, connect, and transition different types of information, such as media information and control information in a relay and cooperative manner. Media information may refer to any data representing content meant for a user, such as voice information, video information, audio information, text information, numerical information, alphanumeric symbols, graphics, images, and so forth. Control information may refer to any data representing commands, instructions or control words meant for an automated system. For example, control information may be used to route media information through a system, or instruct a node to process the media information in a predetermined manner. The nodes of system 300 may communicate media and control information in accordance with one or more protocols as described herein. The embodiments are not limited in this context.

Embodiments of system 300 may include one or more fixed, stationary or mobile client devices and network points of attachment, such as nodes 110, 120, 130 described with reference to FIG. 1. In one embodiment, for example, nodes 110 and 120 may comprise client devices 160, 162, and node 130 may comprise network point of attachment 164 as described with reference to FIG. 1. In various embodiments, the client devices 160, 162 and the network point of attachment 164 each may comprise WiFi, WiMAX, Bluetooth, UWB, and/or cellular compliant modules, or any combinations thereof, to communicate over respective wireless networks, for example. Each node 110, 120, 130 may be arranged to communicate information signals using one or more wireless transmitters/receivers (“transceivers”) or radios, such as IEEE 802.11 Frequency Hopping Spread Spectrum (FHSS) or Direct Sequence Spread Spectrum (DSSS) radios, for example. The embodiments are not limited in this context.

Embodiments of nodes 110, 120, 130 may communicate using the client devices 160, 162, 164 over wireless shared media 140. In one embodiment, wireless shared media 140 may comprise cellular, WiFi, Bluetooth, UWB, and/or WiMAX wireless networks, for example. Each client device 160, 162, 164 may be arranged to operate using the 2.45 Gigahertz (GHz) Industrial, Scientific and Medical (ISM) band of wireless shared media 140 as well as other operating bands, such as, for example, IEEE-802.16 10-66 GHz band, IEEE-802.16a 2-11 GHz band, IEE-802.20 0.5-3.5 GHz band, among others. In the context of a WMAN, a WiMAX wireless broadband network may cover several different frequency ranges. For example, WiMAX technology covers the IEEE 802.16 standard frequencies from 10 GHz to 66 GHz. The 802.16a specification, an extension of IEEE 802.16, covers bands in the 2 GHz-to 11 GHz range. WiMAX technology has a range of up to approximately 30 miles with a typical cell radius of 4-6 miles, for example. WiMAX channel sizes range from 1.5 to 20 MHz, and a WiMAX based network has the flexibility to support a variety of data transmitting rates such as T1 (1.5 Mbps) and higher data transmitting rates of up to 70 Mbps on a single channel that can support thousands of users. Accordingly, a WiMAX network can adapt to the available spectrum and channel widths in different environments such as different countries or may be licensed to different service providers. WiMAX technology also may support ATM, IPv4, IPv6, Ethernet, and VLAN services. In addition, WiMAX may provide a wireless backhaul technology to connect 802.11 WLANs and commercial hotspots with Internet, for example. The embodiments are not limited in this context.

Information signals in various embodiments of system 300 may include any type of signal encoded with information, such as media and/or control information. Although FIG. 3 is shown with a limited number of nodes in a certain topology, it may be appreciated that system 300 may include additional or fewer nodes arranged in any topology as may be desired for a given implementation. The embodiments are not limited in this context.

In one embodiment, system 300 nodes 110, 120, 130 may comprise fixed wireless devices. A fixed wireless device may comprise a generalized equipment set providing connectivity, management, and control of another device, such as a mobile client device. Examples for nodes 110, 120, 130 with fixed wireless devices may include a wireless AP, base station or node B, router, switch, hub, gateway, and so forth. In other embodiments, for example, nodes 110, 120, 130 may comprise WiFi WLAN AP, WiMAX broadband wireless base stations, among other technology APs and/or base stations for WLAN, WMAN, WPAN, WAN, cellular, and others, for example. Although some embodiments may be described with nodes 110, 120, 130 implemented as a WiFi WLAN access point or WiMAX wireless broadband base station by way of example, it may be appreciated that other embodiments may be implemented using other wireless devices and technologies as well. The embodiments are not limited in this context.

In one embodiment, node 130 may provide access to a network 150 via wired communications media. Network 150 may comprise, for example, a packet network such as Internet, a corporate or enterprise network, a voice network such as the Public Switched Telephone Network (PSTN), and so forth. The embodiments are not limited in this context.

In one embodiment, system 300 nodes 110, 120, 130 may comprise, for example, multiple mobile or fixed client devices 160, 162, 164 adapted with wireless capabilities. Each mobile or fixed wireless client device 160, 162, 164 may comprise a generalized equipment set providing connectivity to other wireless devices, such as other mobile devices or fixed devices. For example, nodes 110, 120, 130 may comprise one or more client devices and/or network points of attachment as defined herein. In one embodiment, for example, nodes 110, 120, 130 may comprise one or more wireless devices, such as client devices for WLAN (e.g., WiFi), WMAN (e.g., WiMAX), WPAN (e.g., Bluetooth), and WAN wireless networks, cellular telephone network, radio network, computer, among other wireless communication networks, devices, and systems operating in accordance with the IEEE 802.11, 802.15, 802.16, 802.20, 802.21, 3GPP, 3GGP2 series of standards and/or protocols, for example. In a WLAN (e.g., WiFi) and WMAN (e.g., WiMAX) environment implementation, nodes 110, 120, 130 may comprise WiFi WLAN access point and WiMAX wireless broadband base stations. Although some embodiments may be described with client devices in nodes 110, 120, 130 implemented as mobile stations for a WLAN by way of example, it may be appreciated that other embodiments may be implemented using other wireless devices as well. For example, nodes 110, 120, 130 also may be implemented as fixed devices such as a computer, a mobile subscriber station (MSS) for a WMAN, and so forth. The embodiments are not limited in this context.

Nodes 110, 120, 130 and/or each fixed or mobile client device 160, 162, 164 associated therewith may comprise one or more wireless transceivers and antennas. In one embodiment, for example, nodes 110, 120, 130 and/or each fixed or mobile client device 160, 162, 164 may comprise multiple transceivers and multiple antennas. The use of multiple antennas may be used to provide a spatial division multiple access (SDMA) system or a MIMO system in accordance with one or more of the IEEE 802.11n proposed standards, for example. The embodiments are not limited in this context.

In general, the nodes of system 300 may operate in multiple operating modes. For example, nodes 110, 120, 130 and/or each fixed or mobile client device 160, 162, 164 may operate in at least one of the following operating modes: a single-input-single-output (SISO) mode, a multiple-input-single-output (MISO) mode, a single-input-multiple-output (SIMO) mode, and/or in a MIMO mode. In a SISO operating mode, a single transmitter and a single receiver may be used to communicate information signals over wireless shared media 140. In a MISO operating mode, two or more transmitters may transmit information signals over wireless shared media 140, and information signals may be received from wireless shared media 140 by a single receiver of a MIMO system. In a SIMO operating mode, one transmitter and two or more receivers may be used to communicate information signals over wireless shared media 140. In a MIMO operating mode, two or more transmitters and two or more receivers may be used to communicate information signals over wireless shared media 140. The embodiments are not limited in this context.

In one embodiment of system 300, nodes 110, 120 may be implemented as wireless client devices compliant with WLAN (e.g., WiFi), WMAN (e.g., WiMAX), WPAN (e.g., Bluetooth), Wireless Wide Area Network (WWAN), and cellular telephone standards and/or protocols. Client devices 160, 162 may communicate in a point-to-point basis between nodes 110, 120. Node 130 may be implemented as a network point of attachment node to communicate with nodes 110, 120 and network 150. In a WiMAX based network environment, network point of attachment node 130 may service a radius of several miles/kilometers (long range) and is responsible for communicating on a point-to-multi-point basis between node 130 and nodes 110, 120, for example. To communicate with node 130 nodes 110, 120 may first need to associate with network point of attachment node 130. Once client device nodes 110, 120 are associated with network point of attachment node 130 client devices 160, 162 may need to select a data rate for data frames with media and control information over wireless shared media 140. Client device nodes 110, 120 may select a data rate once per association, or may periodically select data rates to adapt to transmitting conditions of wireless shared media 140. Adapting data rates to transmitting conditions may sometimes be referred to as rate adaptation operations. In one embodiment of system 300, several client devices 160, 162 at respective nodes 110, 120 can cooperate and transmit messages simultaneously to communicate with node 130, a destination that may not be reached otherwise by client devices 160, 162 alone for various reasons. Beam forming and diversity gain enables cooperative network functionality of system 300. For example, in one embodiment, system 300 provides a heterogeneous wireless cooperative network adapted to operate with several different wireless technologies. For example, in one embodiment, nodes 110, 120 of system 300 may be adapted to operate with WiFi (or Bluetooth/UWB) and WiMAX client devices, although the embodiments are not limited in this context. Client devices 160, 162 are not limited to WiFi, Bluetooth, UWB, and the like and cooperative wireless devices are not limited to WiMAX cooperative communications. For example, client devices 160, 162 may comprise any client device adapted to operate in a cooperative radio environment. For example, any client device adapted for fast, short range, and flexible/ad hoc radio functionality that may serve as a relay link for nodes 110, 120. Any network point of attachment may be adapted for long range, scheduled periodic radio functionality to form cooperative simultaneous communication links between nodes 110, 120 and node 130, for example. The embodiments are not limited in this context.

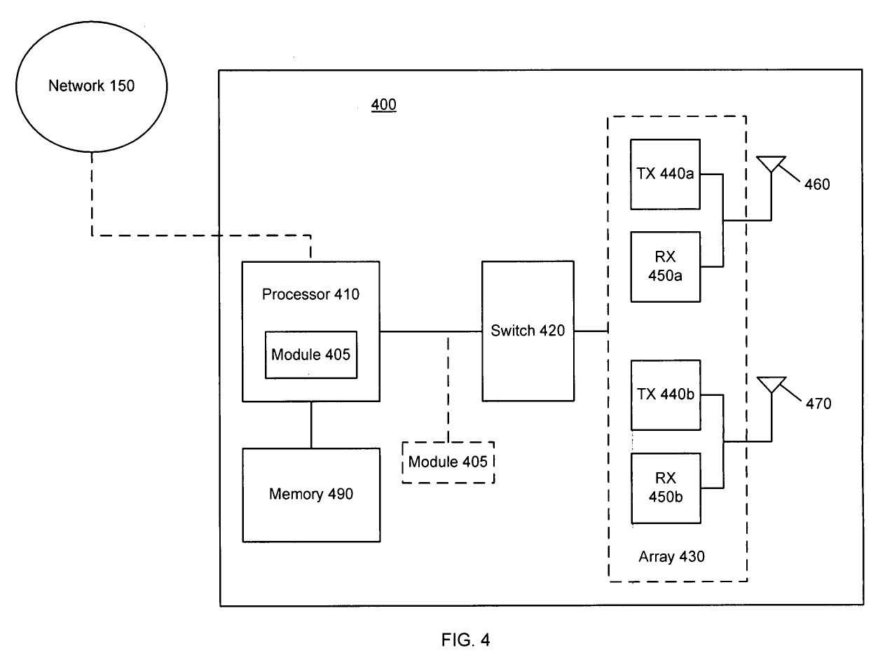

FIG. 4 illustrates one embodiment of a wireless device 400. In various embodiments, wireless device 400 may be fixed or mobile and is representative of wireless devices 160, 162, 164 described herein with reference to any one of respective nodes 110, 120, 130. FIG. 4 may illustrate a block diagram of one embodiment of a wireless device 400 of systems 100, 300, for example, and may be implemented as part of nodes 110, 120, 130 as a fixed or mobile wireless device and/or network point of attachment device similar to client devices 160, 162 and network point of attachment device 164 described with reference to FIGS. 1 and 2. As shown in FIG. 4, wireless device 400 may comprise multiple elements, such as processor 410, switch (SW) 420, transceiver array 430, and memory 490. In one embodiment, wireless device 400 also may comprise a cooperative communications manager module 405. Device 400 may comprise several elements, components or modules, collectively referred to herein as a “module.” A module may be implemented as a circuit, an integrated circuit, an application specific integrated circuit (ASIC), an integrated circuit array, a chipset comprising an integrated circuit or an integrated circuit array, a logic circuit, a memory, an element of an integrated circuit array or a chipset, a stacked integrated circuit array, a processor, a digital signal processor, a programmable logic device, code, firmware, software, and any combination thereof. Although FIG. 4 is shown with a limited number of modules in a certain topology, it may be appreciated that device 400 may include additional or fewer modules in any number of topologies as desired for a given implementation. The embodiments are not limited in this context.

Some elements may be implemented using, for example, one or more circuits, components, registers, processors, software subroutines, or any combination thereof. Although FIG. 4 shows a limited number of elements, it can be appreciated that more or less elements may be used in wireless device 400 as desired for a given implementation. The embodiments are not limited in this context.

In one embodiment, wireless device 400 may include transceiver array 430. Transceiver array 430 may be implemented as, for example, a MIMO system. MIMO system 430 may include two transmitters 440a and 440b, and two receivers 450a and 450b. Although MIMO system 430 is shown with a limited number of transmitters and receivers, it may be appreciated that MIMO system 430 may include any desired number of transmitters and receivers. The embodiments are not limited in this context.

In one embodiment, transmitters 440a-b and receivers 450a-b of MIMO system 430 may be implemented as OFDM transmitters and receivers. Transmitters 440a-b and receivers 450a-b may communicate packets with other wireless devices over respective channels, for example. In one embodiment, for example, when implemented in nodes 110, 120 as part of respective client devices 160, 162, transmitters 440a-b and receivers 450a-b may communicate packets with wireless device 164 of network point of attachment node 130. When implemented as part of node 130, transmitters 440a-b and receivers 450a-b of wireless device 164 may communicate packets with client devices 160, 162 of respective nodes 110, 120. The packets may be modulated in accordance with a number of modulation schemes, to include Binary Phase Shift Keying (BPSK), Quadrature Phase-Shift Keying (QPSK), Quadrature Amplitude Modulation (QAM), 16-QAM, 64-QAM, and so forth. The embodiments are not limited in this context.

In one embodiment, transmitter 440a and receiver 450a may be operably coupled to antenna 460, and transmitter 440b and receiver 450b may be operably coupled to antenna 470. Examples for antenna 460 and/or antenna 470 may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. In one embodiment, systems 100, 300 may be implemented as a MIMO based WLAN comprising multiple antennas to increase throughput and may trade off increased range for increased throughput. MIMO-based technologies may be applied to other wireless technologies as well. Although in one embodiment system 300 may be implemented as a WLAN in accordance with IEEE 802.11a/b/g/n protocols for wireless access in an enterprise, other embodiments in use in the enterprise may include reconfigurable radio technologies and/or multiple radios (e.g., multiple transceivers, transmitters, and/or receivers), for example. The embodiments are not limited in this context.

In one embodiment, wireless device 400 may include a processor 410. Processor 410 may be implemented as a general purpose processor. For example, processor 410 may comprise a general purpose processor made by Intel® Corporation, Santa Clara, Calif. Processor 410 also may comprise a dedicated processor, such as a controller, microcontroller, embedded processor, a digital signal processor (DSP), a network processor, an input/output (I/O) processor, a media processor, and so forth. The embodiments are not limited in this context.

In one embodiment, processor 410 may comprise cooperative communications manager module 405. In one embodiment, cooperative communications manager module 405 may be arranged to control the transmission of packets on respective channels between any one of nodes 110, 120, 130, for example, over a heterogeneous wireless cooperative network embodiment of system 300. In one embodiment, cooperative communications manager module 405 provides includes functional blocks to implement a cooperative architecture including a combination WiFi, Bluetooth, UWB, WiMAX, cellular, among other wireless technology radios, for example. This cooperative architecture may be implemented on a platform of wireless device 400 to establish point-to-point links between two nearby nodes (e.g., nodes 110, 120) to dispatch relay messages and to cooperate with a network point of attachment node (e.g., node 130) by beam forming, for example. The embodiments are not limited in this context.

In one embodiment, wireless device 400 may include a memory 490. Memory 490 may comprise any machine-readable or computer-readable media capable of storing data, including both volatile and non-volatile memory. For example, the memory may comprise read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. The embodiments are not limited in this context.

In one embodiment, processor 410 may be arranged to perform MAC layer operations. For example, processor 410 may be implemented as a MAC processor. MAC 410 may be arranged to perform MAC layer processing operations. In addition, MAC 410 may be arranged to select a data rate to communicate media and control information between wireless devices over wireless shared media 140 in accordance with one or more WLAN protocols, such as one or more of the IEEE 802.11n proposed standards, for example. The embodiments, however, are not limited in this context.

When implemented in a node of system 100 or 300, wireless device 400 may be arranged to communicate information in wireless shared media 140 between the various nodes, such as client device nodes 110, 120, and network point of attachment node 130. The information may be communicated in the form of packets over respective channels established with each packet comprising media information and/or control information. In one embodiment, packets may be transmitted between nodes 110, 120, 130 simultaneously using different frequencies as may be set or allocated by node 130, for example. The media and/or control information may be represented using, for example, multiple OFDM symbols. Packets may be part of a frame, which in this context may refer to any discrete set of information, including a unit, packet, cell, segment, fragment, and so forth. The frame may be of any size suitable for a given implementation. Typical WLAN protocols use frames of several hundred bytes, and an IEEE 802.11 frame may have a length of up to 1518 bytes or more, for example. In one embodiment, nodes of system 100 or 300 and wireless device 400 may be arranged to communicate information over wireless shared media 140 between the various nodes, such as client device nodes 110, 120, and network point of attachment node 130. Although embodiments describe communication of information in the form of packets over respective wireless channels, the embodiments are not limited in this context.

When implemented as part of a client device node 110, 120, MAC 410 may be arranged to associate with a network point of attachment. For example, MAC 410 may passively scan for various network points of attachment nodes 130, such as, for example, WiFI WLAN access points or WiMAX wireless broadband base stations. Wireless point of attachment node 130 may broadcast a beacon periodically. The beacon may contain information about the network point of attachment including a service set identifier (SSID), supported data rates, cooperation frequencies, and so forth. MAC 410 of each client device 160, 162 may use this information and the received signal strength for each beacon to compare multiple network points of attachments and decide upon which one to use. Alternatively, MAC 410 may perform active scanning by broadcasting a probe frame, and receiving probe responses from network point of attachment node 130. Once a network point of attachment (e.g., WiMAX base station, WiFi access point, among others) has been selected, MAC 410 may perform authentication operations to prove the identity of the selected network point of attachment. Authentication operations may be accomplished using authentication request frames and authentication response frames. Once authenticated, client device nodes 110, 120 associate with the selected network point of attachment node before sending packets. Association may assist in synchronizing client device nodes 110, 120 and the network point of attachment node 130 (e.g., AP or base station) with certain information, such as supported data rates. Association operations may be accomplished using association request frames and association response frames containing elements such as SSID and supported data rates. Once association operations are completed, client device nodes 110, 120 and network point of attachment node 130 can send packets to each other, although the embodiments are not limited in this regard.

In some embodiments, MAC 410 also may be arranged to select a data rate to communicate packets based on current channel conditions for wireless shared media 140. For example, assume client device node 110 associates with a peer, such as an AP or other wireless device (e.g., client device node 120). Client device node 110 may be arranged to perform receiver directed rate selection. Consequently, client device node 110 may need to select a data rate to communicate packets between client device node 110 and network point of attachment node 130 prior to communicating the packets.

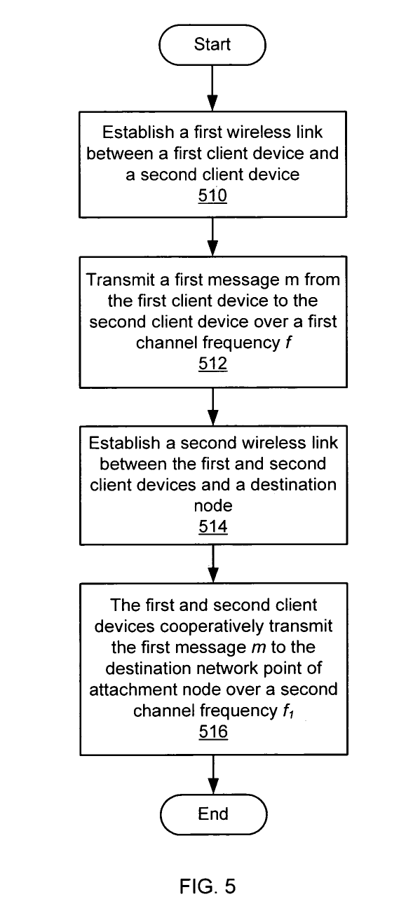

FIG. 5 illustrates one embodiment of a logic flow 500 of information exchanged between heterogeneous wireless devices in heterogeneous wireless network 100. Logic flow 500 may be representative of the operations executed in one or more systems described herein. For example, in one embodiment a first wireless link is established (510) between first client device 160 at S node 110 and second client device 162 at R node 120. A first message m is transmitted (512) from first client device 160 to second client device 162 on first channel frequency f. A second wireless link is established (514) between first and second client devices 160, 162 and destination network point of attachment node 130. First and second client devices 160, 162 cooperatively transmit (516) the first message m to destination network point of attachment node 130 on second channel frequency f₁. The embodiments are not limited in this context.

In one embodiment, the first wireless link is established over a first wireless network and the second wireless link is established over a second wireless network. The first wireless network may comprise a WiFi WLAN, a Bluetooth WPAN, and a cellular network and the second wireless network comprises a WiMAX WMAN. In one embodiment, the first message comprises coordination information for beam forming. The coordination information may comprise uplink frame identification information, adaptive modulation and coding (AMC) band index, and/or channel information. The embodiments are not limited in this context.

In one embodiment, first client device 160 may receive a second message from second client device 162. First client device 160 may establish a third wireless link with destination network point of attachment node 130 and transmits the second message from first client device 160 to destination network point of attachment node 130 over the third wireless link. The embodiments are not limited in this context.

In one embodiment, prior to cooperating (e.g., beam forming) first and second client devices 160, 162 learn channel state information from first client device 160 to destination network point of attachment node 130 and learn the channel state information from second client device 162 to destination network point of attachment node 130. The channel state information for first client device 160 is represented in terms of magnitude and phase as α_{S}e^{jθ}^{_{S}} and the second channel state information is represented in terms of magnitude and phase as α_{R}e^{jθ}^{_{R}}. The respective first and second client devices 160, 162 may multiply a first signal representing the first message m from the first client device by e^{-jθ}^{_{S}} and may multiply a second signal representing the first message m from the second client device by e^{-jθ}^{_{R}}. It will be appreciated that this may be equivalent to multiplying the first message by e^{-j(θ}^{_{S}}^{-θ}^{_{R)}} only, for example. The amplitude α_{S} and α_{R} may be included for a Maximum Ratio Combining (MRC) implementation, for example. Those skilled in the art will appreciate that a MRC implementation provides a way (in the sense of the least bit error rate or BER) to use information from different paths to achieve decoding in an additive white Gaussian channel (AWGN), for example. For example, in one implementation, a receiver corrects the phase rotation caused by a fading channel and then combines the received signals of different paths proportionally to the strength of each path. Because each path may undergo different attenuations, combining them with different weights may yield an optimum solution under an AWGN channel, for example. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, i, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising a cooperative communications manager module to establish a first wireless link with a client device using a first channel frequency and to dispatch a first message to said client device over said first channel frequency and to establish a second wireless link with a destination node and to control a cooperative transmission of said first message simultaneously with said client device to said destination node over said second wireless link using a second channel frequency.

2. The apparatus of claim 1, wherein said cooperative communications manager module is to establish said first wireless link with said client device using a first wireless device and is to establish said second wireless link with said destination node using a second wireless device.

3. The apparatus of claim 2, wherein said first wireless device is adapted to operate in a first wireless network and said second wireless device is adapted to operate in a second wireless network.

4. The apparatus of claim 3, wherein said first wireless network comprises any one of a wireless local area network (WLAN), wireless personal area network (WPAN), and cellular telephone network and wherein said second wireless network comprises a wireless metropolitan area network (WMAN).

5. The apparatus of claim 1, wherein said first message comprises coordination information for beam forming.

6. The apparatus of claim 5, wherein said coordination information comprises any one of uplink frame identification information, adaptive modulation and coding (AMC) band index, and channel information.

7. The apparatus of claim 1, wherein said cooperative communications manager module is to receive a second message intended for said destination node from said client device over said first wireless link using said first wireless device and is to establish a third wireless link with said destination node using said second wireless device to transmit said second message to said destination node.

8. The apparatus of claim 1, wherein said first wireless link is a point-to-point wireless link.

9. The apparatus of claim 1, wherein said first channel is an asynchronous channel.

10. The apparatus of claim 1, wherein said second channel is a synchronous channel.

11. The apparatus of claim 1, wherein the said first channel frequency and said second channel frequency are the same.

12. A system, comprising:
an antenna; and
a cooperative communications manager module to establish a first wireless link with a client device using a first channel frequency and to dispatch a first message to said client device over said first channel frequency and to establish a second wireless link with a destination node and to control a cooperative transmission of said first message simultaneously with said client device to said destination node over said second wireless link using a second channel frequency.

13. The system of claim 12, wherein said cooperative communications manager module is to establish said wireless link with said client device using a first wireless device and is to establish said second wireless link with said destination node using a second wireless device.

14. The system of claim 13, wherein said first wireless device is adapted to operate in a first wireless network and said second wireless device is adapted to operate in a second wireless network.

15. The system of claim 14, wherein said first wireless network comprises any one of a wireless local area network (WLAN), wireless personal area network (WPAN), and cellular telephone network and wherein said second wireless network comprises a wireless metropolitan area network (WMAN).

16. The system of claim 12, wherein said first message comprises coordination information for beam forming.

17. The system of claim 16, wherein said coordination information comprises any one of uplink frame identification information, adaptive modulation and coding (AMC) band index, and channel information.

18. The system of claim 12, wherein said cooperative communications manager module is to receive a second message intended for said destination node from said client device over said first wireless link using said first wireless device and is to establish said second wireless link with said destination node using said second wireless device to transmit said second message to said destination node.

19. The system of claim 12, wherein the said first channel frequency and said second channel frequency are the same.

20. A method, comprising:
establishing a first wireless link between a first client device and a second client device;
transmitting a first message from said first client device to said second client device over a first channel frequency;
establishing a second wireless link between said first and second client devices and a destination node; and
said first and second client devices cooperatively transmitting said first message to said destination node over a second channel frequency.

21. The method of claim 20, comprising establishing said first wireless link over a first wireless network, and establishing said second wireless link over a second wireless network.

22. The method of claim 21, comprising said first wireless network comprises any one of a wireless local area network (WLAN), a wireless personal area network (WPAN), and a cellular network and said second wireless network comprises a wireless metropolitan area network (WMAN).

23. The method of claim 20, wherein transmitting said first message comprises transmitting coordination information for beam forming.

24. The method of claim 23, wherein said coordination information comprises any one of uplink frame identification information, adaptive modulation and coding (AMC) band index, and channel information.

25. The method of claim 20, comprising:
receiving a second message at said first client device from said second client device;
establishing a third wireless link with said destination node; and
transmitting said second message from said first client device to said destination node over said third wireless link.

26. The method of claim 20, comprising:
learning a channel state information from said first client device to said destination node;
learning said channel state information from said second client device to said destination node;
wherein said channel state information for said first client device is represented in terms of magnitude and phase as α_{S}e^{jθ}^{_{S}}; and
wherein said second channel state information is represented terms of magnitude and phase as α_{R}e^{jθ}^{_{R}}; and
multiplying a first signal representing said first message from said first client device by e^{-jθ}^{_{S; and}}
multiplying a second signal representing said first message from said second client device by e^{-jθ}^{_{R}}.

27. The method of claim 26, comprising:
multiplying said first signal representing said first message from said first client device by α_{S}e^{-jθ}^{_{S}}; and
multiplying said second signal representing said first message from said second client device by α_{R}e^{-jθ}^{_{R}}.

28. The method of claim 26, comprising:
multiplying said first signal representing said first message from said first client device by
$$\frac{{α}_{S}}{{α}_{R}} {ⅇ}^{- j ( {θ}_{S} - {θ}_{R} )} .$$

29. The method of claim 26, comprising:
multiplying said first signal representing said first message from said first client device by .e^{-j(θ}^{_{S}}^{-θ}^{_{R)}}.
